(19) United States
(12) Patent Application Publication
(10) Pub. No.: US 2016/0292588 A1
(43) Pub. Date: Oct. 6, 2016

(54) A METHOD AND AN APPARATUS FOR EFFICIENT DATA PROCESSING

(71) Applicant: Wojciech BURKOT, Krakow (PL)

(72) Inventor: Wojciech BURKOT, Krakow (PL)

(21) Appl. No.: 15/038,453

(22) PCT Filed: Nov. 22, 2013
(86) PCT No.: PCT/IB2013/060341

§ 371 Date: May 21, 2016

(30) Foreign Application Priority Data
Nov. 21, 2013 (PL) P.406171

(51) Int. Cl. G06N 99/00; G06F 9/30

(52) U.S. Cl. CPC G06N 99/002; G06F 9/30101

(57) ABSTRACT

The subject of the invention is a method and an apparatus for efficient data processing, using principles of Quantum Mechanics. A method of evolving a quantum register from an initial state ψ to a desired final state ψ_{yes} of said register characterized by comprising of backtracking to the state computationally equivalent to initial state ψ by mapping each and every unknown, undesirable final state ψₙₒₜ of the quantum register to the superposition or ensemble of orthogonal states in the computations space, when the projection measurement of a quantum register or parts of said register rendered it in the undesirable state ψₙₒₜ.

The subject of the invention is a method and an apparatus for efficient data processing, using principles of Quantum Mechanics.

The known quantum computers are using principles of Quantum Mechanics, where a final state of an evolution of the quantum system represents solution to a computing problem, and where said evolution is equivalent to the computing process. Appropriate design of said evolution is equivalent to creating the algorithm for solving the problem at hand.

There is known quantum algorithm for Quantum Computer, so called Grover's algorithm, designed for searching for a marked element in unordered database of M elements. While classically the number of steps needed to solve this problem scales as M, Grover's algorithm uses only M^{1/2} steps, so provides quadratic speedup. In this Quantum Computation, the search problem is reduced to the design of appropriate unitary transformations, amplifying the amplitude of a marked element and, by doing so, increasing the probability of finding said element by a final measurement.

The main limitation of practical Quantum Computation is decoherence—a loss of information related to the loss of quantum entanglement of a Quantum Computer register state as a result of interaction with the environment, especially limiting in the case of amplitude enhancement algorithms, such as the Grover's algorithm described above.

The measurement (readout) might be such an interaction leading to decoherence, however if the measurement is repeated with appropriate frequency it is a decoherence preventing measure.

A subject of this disclosure is a new method for solving hard computing problems with Quantum Computer which uses backtracking and is weakly susceptible to decoherence contrary to amplitude enhancing algorithms, as the result is achieved by reducing the search space, while maintaining all the candidates compatible with the current set of conditions within the reduced space.

In particular, the subject of the invention is a method using backtracking: evolving the state of the quantum register from initial state ψ to the desired final state ψ_{yes} of said register and backtracking to the state computationally equivalent to initial state ψ by mapping each and every unknown, undesirable final state ψₙₒₜ of the quantum register to the superposition or ensemble of orthogonal states in the space spanned by ψ_{equiv}, in case when the projection measurement of a quantum register or parts of said register rendered it in the undesirable state ψₙₒₜ. A computationally equivalent state ψ_{equiv} is understood here as the state differing from ψ at most by having amplitudes associated with the state ψₙₒₜ being 0 and all amplitudes of ψ_{yes} being not 0. ψ_{yes} or ψₙₒₜ can be degenerate in the computational space, being superpositions or ensembles of states ψ^{k}_{yes} or ψ^{k}ₙₒₜ.

The mapping can be an unitary operator or a sequence of Hermitean projecting measurements or an arbitrary sequence of unitary transformations or Hermitaean measurements.

The subject of the invention is also a method of reduction of a state ψ of a quantum register which is a superposition or an ensemble of desired states ψ_{yes} and undesired ψₙₒₜ, where amplitude coefficients or the probabilities of the ensemble are not known, to the desired superposition state ψ_{yes}, characterized in that in the case of measurement projecting ψ to the undesired ψₙₒₜ, any of the backtracking methods claimed by any of claims 1, 3, 4, 5 is applied to restore the state of the register to the state ψ_{equiv}, equivalent to ψ and repeating the sequence of measurement-backtracking, until the state ψ_{yes} is found or until probability that the solution exists given the number of unsuccessful retries falls below a preset threshold.

This method can be used when the state ψ is a degenerate state in the computation space, ψ_{yes} or ψₙₒₜ being, respectively superpositions or ensembles of states ψ_{yes}^{k} or ψₙₒₜ^{k}.

Also a method described above characterized in that the mapping can be an unitary operator or a sequence of Hermitean projecting measurements or an arbitrary sequence of unitary transformations or Hermitaean measurements and operate in orthogonal subspaces in the computational space, which includes but is not limited to the operation on a subset of qbits.

The subject of the invention is also a method of reducing register characterized in that, in the case of exponentially large dimension of the search space N=2ⁿ where n is the length of the register, the dimensionality of the search space is recursively reduced at each step by using any method of claim 6, 7 or 8 such that the resulting state ψ_{yes} of previous step is the initial state ip of the next step, and the measurements and backtracking transformations claimed in 1, 3, 4 or 5 do not increase the dimensionality of current space beyond that of the initial state ψ of a step, so the sequence of k steps allows for exponential speedup of the order of average dimension reduction dimψ/dim ψ_{yes} raised to the number of steps k.

The subject of the invention is also a quantum computer characterized in that at least one of the qbits q in the register |x,q> is available for the projecting measurement H, in such a way that reduction of the said qbit to 0 or 1 does not destroy the state of the remaining part of the register, merely reducing x to the state compatible with the resulting value of q e.g. |x₀, 0> or |x₁, 1>.

### EXAMPLES OF USAGE

For clarity, the following will describe the method in the pure state formalism, however it can be also described in the density operator formalism for mixed states (ensemble) case.

The disclosed novel method of solving hard computational problems on Quantum Computer is based on the ability to backtrack. The following procedure exactly matches classical breadth first algorithms with backtracking and, as such, scales quadratically worse than optimal Grover's search, however it yields correct result with the probability exponentially close to 1 and leaves the system in the desired state ψ_{yes} when the solution has been found, thus allowing recursive, breadth first brute force pruning in the case the problem being solved has a structure lending itself to such a solution. The advantage over a classical computer is the ability of the quantum computer to operate an exponentially larger search space than its classic counterpart.

1. Create a superposition of all the potential solutions to the problem in the first part of the quantum register and initialize to 0 the last qubit: |x,0>.

2. Assuming verification of the solution can be performed efficiently, like in a case of NP-Complete problems, the function yielding 1 for the the actual solution or solutions and 0 for non-solution can be calculated efficiently for all the x^{k}, yielding: |x,f(x)>.

3. Apply the single qubit measurement H_{f} to the last qubit of the register, projecting the state to either desired state |x_{yes},1>, with x_{yes} being a solution or solutions, which terminates the operation or projecting it to undesired |xₙₒₜ,0>. In the latter case, the backtracking of claim is performed leaving the register in the state |x_{equiv},0>.

4. The procedure is repeated until the solution is found in step 2 described above or until the probability that the solution exists given the number of unsuccessful retries falls below a preset threshold.

{A Trivial Example} Let's assume we want to draw, with certainty, a white ball from an urn containing an unknown number of white and black balls. Classically, this can not be done, however when the urn is represented by a quantum state |ψ>=a |1>+b|0)>, assuming |1> is a white ball, with randomness provided by unknown amplitudes a and b, the following backtracking based method works with certainty: let H be a measurement operator on |ψ>. Then, applying <ψ|H|ψ> renders ψ in desired state |1> with probability a². If this is a case, method terminates, but when the measurement returns |0> we apply an unitary transformation represented in the computational base by U=( ). Subsequent application of H will result in measuring |1> with certainty. Of course, had we applied U before the first application of H which resulted in undesirable state |0>, we would not accomplish the goal.

Thus, ability to “peek” and backtrack in the case of undesirable measurement result is crucial for the success of the method. Note that “peeking” with projection measurement does not violate the requirement of data oblivious quantum information processing. Also note that in this example application of U transforms the register directly to the desirable state ψ_{yes} rather than the original ψ. Hereafter, the meaning of “computationally equivalent” used throughout the claims, is to be understood as the state differing from the initial one at most having amplitude 0 for states from ψₙₒₜ and non-zero amplitudes for ψ_{yes}.

These examples illustrate but do not limit the scope of the invention.

1. A method of evolving a quantum register from an initial state ψ to a desired final state ψ_{yes} of said register characterized in that comprising of backtracking to the state computationally equivalent to initial state ψ by mapping each and every unknown, undesirable final state ψₙₒₜ of the quantum register to the superposition or ensemble of orthogonal states in the computations space, when the projection measurement of a quantum register or parts of said register rendered it in the undesirable state ψₙₒₜ.

2. A method according to claim 1 characterized in that utilizing a degenerate state ψ in the calculation space, i.e. ψ_{yes} or ψₙₒₜ being, respectively, superpositions or ensembles of states ψ_{yes}^{k} or ψₙₒₜ^{k}.

3. A method according to claim 1, characterized in that backtracking is by an unitary operator acting on the quantum state of the register ψₙₒₜ.

4. A method according to claim 1, characterized in that backtracking is a sequence of Hermitean projection measurements.

5. A method, according to claim 1 characterized in that any arbitrary sequence of methods claimed in claims 3 and 4 is used.

6. A method of reduction of a state ψ of a quantum register which is a superposition or an ensemble of desired states ψ_{yes} and undesired ψₙₒₜ, where amplitude coefficients or the probabilities of the ensemble are not known, to the desired superposition state ψ_{yes}, characterized in that in the case of measurement projecting ψ to the undesired ψₙₒₜ, any of the backtracking methods claimed by any of claims 1, 3, 4, 5 is applied to restore the state of the register to the state ψ_{equiv}, equivalent to ψ and repeating the sequence of measurement-backtracking, until the state ψ_{yes} is found or until probability that the solution exists given the number of unsuccessful retries falls below a preset threshold.

7. A method according to claim 6 characterized in that the state ψ is a degenerate state in the computation space, ψ_{yes} or ψₙₒₜ being, respectively superpositions or ensembles of states ψ_{yes}^{k} or ψₙₒₜ^{k}.

8. A method according to claim 6 or 7 characterized in that the transformations described in claim 3, 4 or 5 operate in orthogonal subspaces in the computational space, which includes but is not limited to the operation on a subset of qbits.

9. A method of reducing register characterized in that, in the case of exponentially large dimension of the search space N=2ⁿ where n is the length of the register, the dimensionality of the search space is recursively reduced at each step by using the method 6, 7 or 8 such that the resulting state ψ_{yes} of previous step is the initial state ψ the next step, and the measurements and backtracking transformations claimed in 1, 3, 4 or 5 do not increase the dimensionality of current space beyond the initial state ψ of a step, so the sequence of k steps allows for exponential speedup of the order of average dimension reduction dimψ/dim ψ_{yes} raised to the number of steps k.

10. A quantum computer characterized in that at least one of the qbits q in the register |x,q> is available for the projecting measurement H, in such a way that reduction of the said qubit to 0 or 1 does not destroy the state of the remaining part of the register, merely reducing x to the state compatible with the resulting value of q e.g. |x₀, 0> or |x₁, 1>.
